(19) United States
(12) Patent Application Publication
(10) Pub. No.: US 2012/0201994 A1
(43) Pub. Date: Aug. 9, 2012

(54) FUNCTIONAL LAMINATE

(76) Inventor: Manfred Michalk, Erfurt (DE)

(21) Appl. No.: 13/498,211

(22) PCT Filed: Sep. 30, 2010
(86) PCT No.: PCT/EP2010/064598

§ 371 Date: Apr. 23, 2012

(30) Foreign Application Priority Data
Sep. 30, 2009 (DE) 10 2009 043 587.5

(51) Int. Cl. B32B 3/08; B32B 7/02; B32B 38/04; B32B 37/10; B32B 38/00

(52) U.S. Cl. 428/68; 156/293; 156/242; 156/256

(57) ABSTRACT

The present invention relates to a method for producing a functional laminate (14), wherein the method comprises the following steps:
providing at least one thermoplastic film as the substrate layer (8),
producing at least one aperture (9) in the substrate layer (8),
inserting at least one functional component (1) into the aperture (9),
laminating the substrate layer (8) with at least one additional plastic film as the cover layer (10, 10.1, 10.2) by applying pressure and supplying heat. A soft, elastic and temperature-resistant embedding material is disposed such that the functional component (1) is surrounded by the embedding material at least in the substrate layer (8), said embedding material having a thermal expansion coefficient that is at least as large as a thermal expansion coefficient of the material of the substrate layer (8), wherein the shrinkage behavior of the embedding material and of the material of the substrate layer (8) is similar or the same.

The present invention relates to a functional laminate and a method for the production thereof.

Functional laminates are documents which are produced by laminating a plurality of layers. Functional laminates are used in particular as security documents, such as smart cards, ID cards, credit cards or the like.

Semi-finished products, i.e. so-called prelaminates or inlays which are used for instance for the production of smart cards being furnished with functional components, for instance chips, chip modules, RFID antennas, switches or the like, are also referred to as functional laminates. Functional laminates usually comprise a number of layers and have a chip or a chip module embedded in at least one of said layers. Said layers are frequently made of a plastic material, for instance polycarbonate or polyethylene terephthalate.

The layers are laminated together by applying heat and/or pressure. In this process, the macromolecules of plastic materials tend to shorten, thus causing the plastic material to shrink, i.e. the surface area thereof is reduced while the thickness thereof is increased. However, the chip or the chip module does not shrink, so that mechanical stress is generated which may lead to deformation, cracking or delamination of the material. Mechanical stress may equally result in damage to the functional components or their contacting with conductors, wires or antenna coils or even in destruction of the plastic material in the area surrounding the functional components. These damages or destructions occur especially due to exposure to cold, mechanical stress, such as bending or twisting, and exposure to chemicals, such as detergents or fuels. The resulting damages in the plastic material are visible as cracks and warping for example. Besides the optical drawbacks, the service life of products produced with such functional laminates is reduced.

Another problem is the relatively large thermal expansion coefficient of the plastic material compared to the chip or the chip module. As a result, the chip module having a large surface area acts as a rigid body which has the plastic material shrunk thereon by the lamination process, said plastic material being also rigid below its softening point (high mechanical strength, low elongation). In this process, particularly high stresses which may exceed the mechanical strength of the plastic material are generated in the longitudinal and transversal direction of the laminate directly at the edges of the chip module and in particular at the corners thereof, since in these areas, mechanical stresses acting in the longitudinal and transversal direction overlap with each other. These mechanical stresses are likewise visible as cracks formed in the vicinity of the module. Moreover, compressive stresses act on the module terminals, said stresses being caused by the shrinkage of the plastic material of the inner laminate layer or layers (also called core film), so that the chip module is exposed to mechanical stress. For the purpose of mechanical stress reduction, the terminals being exposed to compressive stresses tend to push the chip module out of the plane of the core film. As a result, the chip module with its relatively sharp and hard edges and corners pointing towards the outer laminate layers (also called cover films or cover foils) pushes against the cover films and in this area, in particular above the corners of the chip module, again causes mechanical stresses leading to cracks in the cover films when said stresses exceed the mechanical strength limit of the plastic material.

Document DE 197 10 656 A1 discloses a chip card which in its interior includes at least one electronic component. Said chip card has a base film which is connected to a core film. Said core film comprises a punched-out area having the at least one electrical component inserted therein. The remaining space between the electronic component and the edges of the punched-out area is filled with a solidified filler which can be processed in fluid form.

Document WO 2007/089140 A1 discloses an ID document which is composed of a carrier and a chip being received therein. Said carrier can be produced by laminating different layers, wherein one or several of said layers are provided with an opening for receiving the chip. The lamination process is performed at relatively high temperatures. The carrier and the chip exhibit different shrinkage properties when cooled, which aspect may lead to stresses resulting in cracking. It is suggested to add an auxiliary layer between the layer being directly adjacent to the chip and the subsequent layer. Said auxiliary layer is composed of a rubbery material having a thermal expansion coefficient which is larger than the thermal expansion coefficient of the two adjacent layers. This aspect leads to pre-stresses in the carrier during cooling following the lamination process, so that crack formation is prevented. In addition, such an auxiliary layer serves as a barrier layer for any kind of crack formation which may occur in the first layer being directly adjacent to the chip. Thanks to the auxiliary layer, cracks occurring in said first layer are prevented from easily spreading into the adjacent second layer, since the properties of the auxiliary layer make it possible to evenly distribute the stresses across the second layer.

Document US 2004/0182939 A1 discloses a thin, electronic chip card having an integrated circuit and a galvanic element as an energy source, said galvanic element having at least one electrode being coated with lithium. Said galvanic element has a thin, flexible housing comprising two metal films which directly press against the electrodes and are connected to each other in a sealed manner with the aid of an adhesive or a sealing layer. The element is disposed in a recess of the chip card. The chip card and the element on both sides thereof are covered by a plastic cover layer which is fixedly connected to the chip card and the element by means of an elastic, stress-compensating adhesive adhering both on metals and plastic materials.

Document EP 0 880 754 B1 discloses a method and a device for bonding a wire conductor to produce a transponder unit which comprises a coil formed of a wire and a chip unit and which is disposed on a substrate. In a first phase, the wire conductor extends across the bonding connection or an area receiving the bonding connection. The wire conductor is affixed to the substrate with respect to the bonding connection or the receiving area. In a second phase, the wire conductor is connected to the bonding connection with the aid of connecting means.

Document DE 44 35 802 A1 discloses a method for producing data carriers having embedded elements and a device for performing said method. The card body of a data carrier having the elements disposed therein is formed in a pressing device from a pressed molding compound. Those elements which are to be embedded in the card body are inserted into the pressing device already prior to the lamination process and are positioned and fixed therein.

Document DE 196 01 202 A1 discloses a data carrier card and a method for the production thereof. Said data carrier card is composed of three basic components. The card body is produced using MID technology and is equipped with all functionalities of the housing and the electrical system. The employed semi-conductor component is an SMD component in a TSOP configuration.

Document DE 102 34 751 B4 discloses a method for producing an injection-molded chip card and a chip card produced according to said method. In the method for producing an injection-molded chip card, which has a chip card body and an antenna coil being embedded in the chip card body for contactless data transfer and being composed of at least one conductor path and contact surfaces connected thereto, the antenna coil is applied on one side onto the flat surface of a carrier film. The carrier film element is inserted into the cavity of an injection molding tool which is of the size of the chip card, such that the antenna coil applied thereon is disposed on the side pointing toward the interior of the cavity. Said cavity is subsequently filled with a liquefied plastic material. Upon termination of the injection-molding process, a recess for a chip module is produced in the chip card body. The contact surfaces of the antenna coil which are disposed in the interior of the chip card body adjacent to the recess are exposed. A chip module is inserted into the recess. The exposed contact surfaces are electrically connected to corresponding terminal faces at the chip module. Following the application of the antenna coil onto the carrier film element, the carrier film element is partially separated in the vicinity of the contact surfaces by means of slotting in such a manner that individual lugs having contact surfaces disposed thereon are formed in the carrier film element. Directly subsequent to the injection-molding process, the lugs formed in the carrier film element are pressed into the still uncured plastic material.

Document DE 195 00 925 C2 discloses a method for producing a contactless chip card. Said chip card comprises a transfer module, which is installed in a card body. The transfer module has an antenna with a large surface area in the form of a coil for inductive data and energy transfer and/or in the form of electrically conductive layers for capacitive data and energy transfer. Moreover, the transfer module has terminal faces for electrical coupling with the chip module. Said transfer module is embedded between laminated layers forming the card body or in a card body which is injection-molded in one piece around the transfer module. Moreover, the chip card comprises a chip module being installed in the card body and having at least one IC component. The chip module has terminal faces via which it is electrically connected to the terminal faces of the transfer module. An intermediate product is produced, which is composed of the transfer module being embedded in the card body. In this process, a cavity for receiving the chip module and being open toward the front side of the card or the rear side of the card is created in the intermediate product in such a manner that the terminal faces of the transfer module are at least partially disposed in the area of the cavity. Only subsequent to this step is the chip module installed in the cavity of the intermediate product in another separate method step to form a functional, contactless chip card. In said method step, the terminal faces of the chip module are electrically conductively connected to the terminal faces of the transfer module.

Document DE 199 42 932 A1 discloses a method for producing chip cards. Firstly, a sheet of at least twice the size of the surface area of a chip card is produced. At least one folding line is produced in said sheet in such a manner that at least the surface area of a chip card remains on each side symmetrically with respect to the folding line. Moreover, at least one component and/or a recess for a component is inserted, respectively applied in or onto the sheet, and the sheet on one side thereof is either completely or partially furnished with an activatable adhesive. Subsequently, the sheet is folded up along the folding line such that the adhesive surface is disposed inwardly, is pressed, and the adhesive is simultaneously activated using a method which leaves the material of the sheet essentially unchanged, namely for instance with the aid of microwaves or else electrically with the aid of resistance welding or in a magnetic field or by a pressing force.

The object of the invention is to suggest an improved functional laminate and a method for the production thereof, wherein the risk of stress-crack formation is reduced.

According to the invention, this object is attained by a method having the features of claim 1 and a functional laminate having the features of claim 14.

Advantageous embodiments of the invention are the subject-matter of the dependent claims.

An inventive method for producing a functional laminate comprises the following steps:
providing at least one thermoplastic film as the substrate layer,
producing at least one aperture in the substrate layer,
inserting at least one functional component into the aperture,
laminating the substrate layer with at least one additional plastic film as the cover layer by applying pressure and supplying heat.

Functional laminates are documents which are formed by laminating a plurality of layers. Functional laminates are used in particular as security documents, such as smart cards, ID cards, credit cards or the like. Semi-finished products, i.e. so-called prelaminates or inlays which are used for instance for producing smart cards being furnished with functional components, for instance chips, chip modules, RFID antennas, switches or the like, are also referred to as functional laminates. The substrate layer of the functional laminate can be formed of a plastic film or of several layers of plastic films.

According to a first embodiment of the invention, a soft, elastic and temperature-resistant embedding material is disposed such that the functional component is surrounded by the embedding material at least in the substrate layer, said embedding material having a thermal expansion coefficient which is at least as large as a thermal expansion coefficient of the material of the substrate layer and preferably also of the cover layer, wherein the embedding material and the material of the substrate layer have a similar or the same shrinkage behavior when heated. A shrinkage value of the embedding material in particular is equal to or larger than a shrinkage value of the material of the substrate layer and preferably also of the material of the cover layer. The shrinkage value refers to a shortening of a specific film in length and width, which occurs as a result of a treatment at a specific temperature over a certain period of time. Shrinkage values can be taken from tables.

The embedding material serves as a buffer material and reduces mechanical stresses in the substrate layer and the cover layers by reducing peak stress. The embedding material distributes the compressive stresses caused as a result of the shrinkage during cooling following the lamination process largely evenly in the aperture and thereby prevents the otherwise occurring lateral pressure acting on the functional component (in particular a chip module and the terminals thereof) from pushing the functional component out of the plane of the substrate layer.

The functional component is pressed or molded into the embedding material in such a manner that the functional component over its surface area is completely embedded in the embedding material. In this regard, a thickness of the embedding material is equal to or almost equal to a thickness of the functional component subsequent to the lamination process.

In particular, the functional component is surrounded by the embedding material only in the substrate layer, but not at all or only insignificantly in the direction of the cover layers.

In this way, the risk of stress-crack formation in the vicinity of the functional component, for instance an integrated circuit (chip) or a chip module, due to the application of heat during the lamination process and shrinkage during cooling, is reduced, in particular in critical areas, such as the corners and edges of the functional component. By means of preventing stress-crack formation, the surface quality of the laminate is improved as well.

According to another embodiment of the invention, a conductor strip or a conductor wire is laid in or on the substrate layer to form a circuit pattern, for instance an antenna coil. Contact points of the conductor strip or the conductor wire are contacted with the terminals of the functional component. The lamination of the substrate layer with at least one additional plastic film as the cover layer by applying pressure and supplying heat is preferably performed subsequent to the contacting of the contact points with the terminals, in particular of course on the substrate side where the contact points and terminals are disposed. Crossing areas of the conductor strip or the conductor wire, which include the contact points, are guided across the aperture on a laying side prior to assembly of the functional component and are bent into the aperture or through the aperture by means of a plunger or by means of the functional component. The conductor strip or the conductor wire is attached to the substrate on both sides of the aperture, for instance is affixed thereto. In this embodiment, provision can equally be made for a soft, elastic and temperature-resistant embedding material which is disposed in such a manner that the functional component is surrounded by the embedding material at least in the substrate layer, said embedding material having a thermal expansion coefficient which is at least as large as a thermal expansion coefficient of the material of the substrate layer, wherein the embedding material and the material of the substrate layer have a similar or the same shrinkage behavior when heated. A shrinkage value of the embedding material in particular is equal to or larger than a shrinkage value of the material of the substrate layer and preferably also of the material of the cover layer. The shrinkage value refers to a shortening of a specific film in length and width, which occurs as a result of a treatment at a specific temperature over a certain period of time. Shrinkage values can be taken from tables.

Preferably, the embedding material is formed as a molded part having a molded part aperture, wherein the functional component is at least partially inserted into the molded part aperture, wherein the molded part is inserted prior to or after insertion of the functional component into the aperture of the substrate. A preassembly of the functional component having the molded part can be realized with high efficiency and the thus created unit is particularly easy to handle. The assembly of said unit with the substrate layer can be performed using conventional production devices, wherein a repeated processing of the substrate layer can be omitted. Due to the usage of the molded part, long lamination times above a softening temperature of the materials can be avoided. By means of the described procedural steps, particularly thin functional laminates having an improved surface quality can be realized, in particular after the ultimate lamination process.

The molded part for instance can also be formed of several molded part pieces made of the same or different materials. The functional component can be at least partially surrounded by several molded part pieces which are connected to each other or which are not connected to each other, wherein this step can be performed prior to or after insertion of the functional component into the aperture.

In particular, a surface of the molded part having the inserted functional component in the top view is smaller than a surface of the aperture, wherein a thickness of the molded part can be larger than a total thickness of the functional component, and wherein a thickness of the substrate layer is almost as large as the thickness of the molded part. Hence, the molded part can be particularly easily inserted into the aperture of the substrate layer.

Also in the first inventive embodiment, a chip module or a chip having at least two terminals can be used as the functional component, wherein a conductor strip or a conductor wire is laid in or on the substrate layer to form a circuit pattern, and wherein contact points of the conductor strip or the conductor wire are contacted with the terminals. A chip module is composed of a thin, flat metallic carrier having a semi-conductor chip mounted on the central area thereof. Said chip is protected with the aid of an injection-molded module body made of a thermosetting or thermoplastic material.

The functional component can be pressed or cast into the molded part. In this context, “cast” means that the functional component is at least partially surrounded by the material of the molded part by casting.

The contact points of the conductor strip or the conductor wire can be contacted with the terminals prior to or after assembly of the functional component with the molded part. In this process, the insulation of the contact points can be stripped already prior to contacting. However, in particular in the contacting process using welding, the contact points can also still be insulated prior to contacting, since the insulation is stripped during the contacting process by the welding.

Preferably, for the purpose of contacting, the contact points of the conductor strip or the conductor wire and/or the terminals are furnished with a solder paste, the melting temperature thereof lying below a temperature which is used for the lamination process, wherein the contact points of the conductor strip or conductor wire are contacted with the terminals during the lamination process. In this context, it is advantageous that an additional welding process is not required.

At least one of the cover layers can be affixed to one side of the substrate layer prior to assembly of the functional component.

Subsequent to the lamination process, the functional laminate can be cooled within a lamination press at a constant or increased pressure below a softening temperature of the material of the substrate layer. In this way, shrinkage of the layers can be further reduced.

The molded part can be produced by casting or hot-stamping or by means of a cutting process or by embedding of the functional component.

Preferably, thermoplastic polyurethane being temperature-resistant up to at least 200° C. is used as the embedding material.

The molded part aperture is preferably smaller than the part of the functional component to be inserted therein, wherein the functional component is pressed into the molded part aperture.

The functional component and/or the molded part is/are preferably heated prior to said pressing process.

Preferably, polycarbonate is used as the material of the substrate layer and/or the cover layer.

The preassembled molded part having the functional component can be inserted into the aperture and can be affixed to the cover layer.

The contact points of the conductor strip or the conductor wire are connected to the terminals, preferably by welding or soldering or by pulsed thermo-compression.

The crossing areas of the conductor strip or the conductor wire can be guided across the aperture on a laying side and can be bent through the aperture to a side of the substrate layer opposite to the laying side by means of a plunger. Subsequently, the chip module or the chip is inserted into the aperture with the terminals thereof pointing ahead.

The molding, bending or pressing-down of the crossing areas of the conductor strip or the conductor wire is advantageous, since on the assembly machine, the further assembly operations can be performed from the laying side of the circuit pattern and turning of the layers is not required. This is particularly advantageous in the case of continuously operating, so-called reel-to-reel machining, or in the case of other automatic machining of the films. The molding of the conductor strips or conductor films is also advantageous if “naked” chips are machined instead of chip modules, the small dimensions thereof resulting in lower mechanical stresses, so that embedding material is not absolutely mandatory. The soft conductor strips or conductor wires coated with insulating lacquer, when being properly positioned, reduce peak stress in the material of the substrate layer along some sharp edges of the chip or the chip module.

When making use of a conductor wire having a round cross-section, the contact points thereof can be pressed against an anvil by means of a plunger and thereby can be leveled, so that a wider contact surface is obtained.

Usually, the use of insulated conductor wire or insulated conductor strip is necessary. In this context, the insulation of contact points of the conductor strip or the conductor wire can be stripped prior to contacting, in particular if the conductor is supposed to be soldered. This can be performed with the aid of a CO₂ laser. If the conductor is contacted with the aid of welding, it is not absolutely necessary to strip the insulation beforehand.

In a preferred embodiment, the molded part is affixed to one of the cover layers. The functional component is affixed to another one of the cover layers. The circuit pattern is laid on the substrate layer with crossing areas of the conductor strip or the conductor wire which are guided across the aperture. The substrate layer and the cover layer having the functional component are affixed to each other such that the terminals of the functional component bend the crossing areas of the conductor strip or the conductor wire through the aperture, so that the contact points, viewed from the laying side, are disposed below the terminals, whereupon the contacting is performed. Eventually, the cover layer having the molded part is affixed to the substrate and is subsequently laminated.

It is an advantage of said arrangement that the conductor wire or the conductor strip lies below the terminal of the chip module into the direction of the center of the substrate layer, so that any kind of notching effect of the conductor strip or the conductor wire, which would otherwise exert a pressing force above the terminals into the very thin cover layer, is precluded.

The affixing of the cover layers to the substrate layer, of the functional component to the cover layer or of the molded part to the cover layer can be performed thermally or else with the aid of an adhesive.

In particular, the functional component is affixed to the cover layer with the aid of an adhesive surface, wherein the adhesive surface is larger than a surface of the functional component. The adhesive layer additionally counteracts the formation of stresses and hence crack formation.

A material of the cover layer and the material of the substrate layer preferably have the same thermal expansion coefficient and a similar or the same shrinkage behavior when heated. In particular, the substrate layer and the cover layer are made of the same material.

Several functional laminates can be produced simultaneously or consecutively as part of a multiple printed panel in the form of a sheet or a reel.

The thickness of the molded part is slightly larger than the total thickness of the terminals and the module body, since the molded part can then be easily inserted into the aperture of the substrate layer which again has a slightly larger surface area.

Hereinafter, exemplary embodiments of the invention will be described in greater detail with reference to the drawings.

In the drawings:

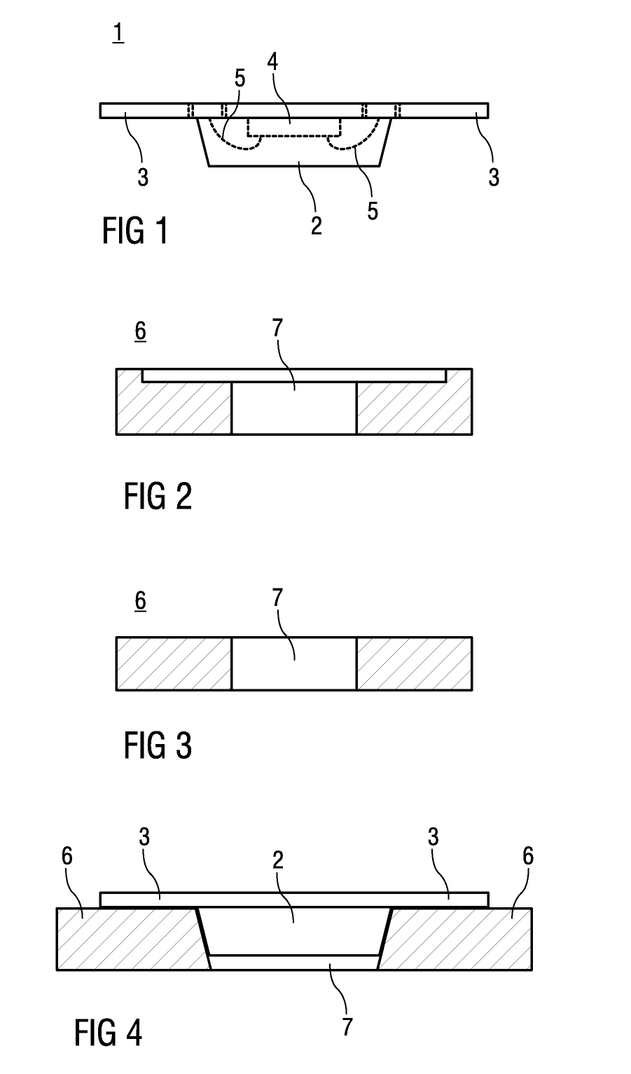

FIG. 1 shows a cross-sectional view of a chip module, comprising a module body and two terminals for contacting;

FIG. 2 shows a cross-sectional view of a molded part for receiving the chip module according to FIG. 1 in a molded part aperture;

FIG. 3 shows a cross-sectional view of another embodiment of a molded part for receiving the chip module according to FIG. 1 in a molded part aperture;

FIG. 4 shows a molded part produced by a cutting process subsequent to the pressing of the module body into the molded part aperture;

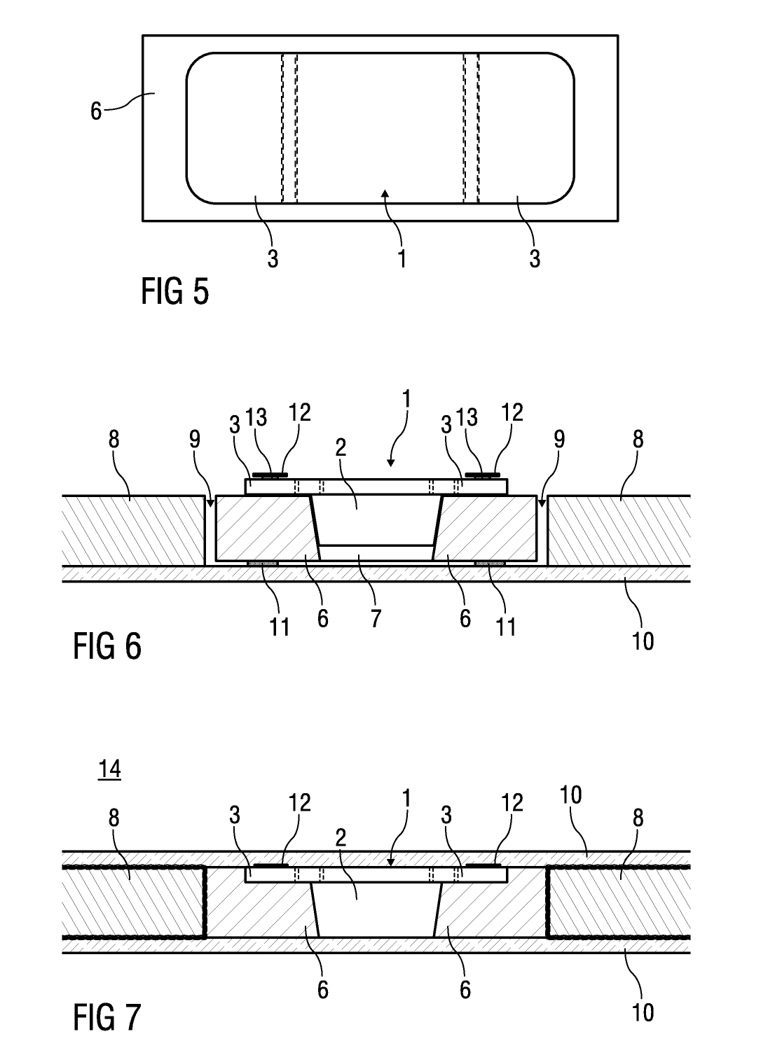

FIG. 5 shows the molded part according to FIG. 4 in the top view;

FIG. 6 shows a substrate layer having an aperture for receiving the molded part and a cover layer;

FIG. 7 shows a cross-sectional view of a functional laminate in the form of a prelaminate;

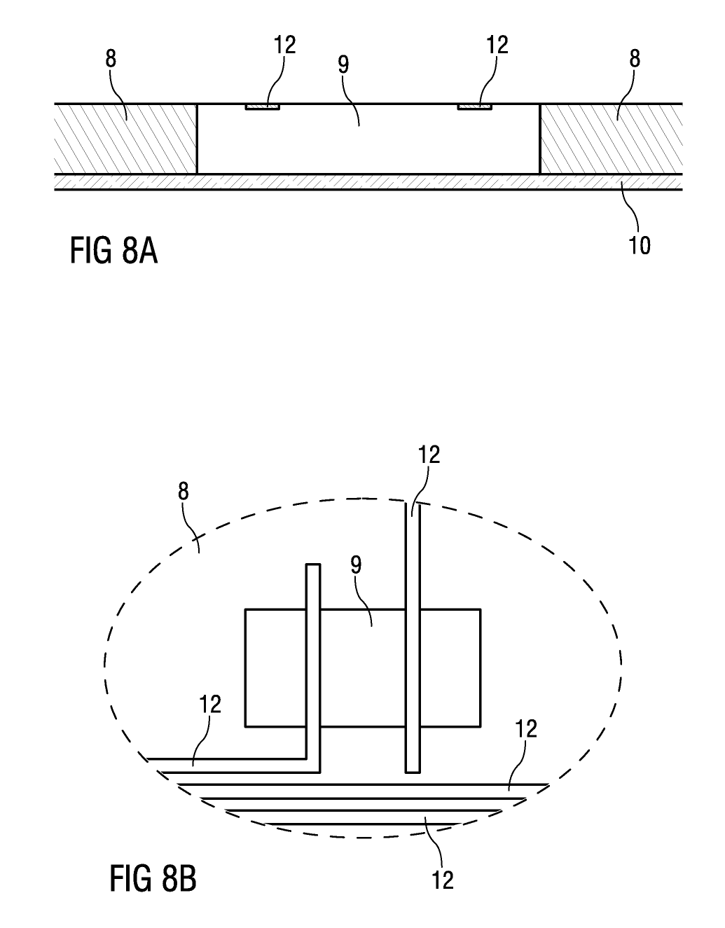

FIG. 8 shows a substrate layer having a cover layer affixed thereunder subsequent to the laying of a conductor strip on an upper surface of the substrate layer across the aperture;

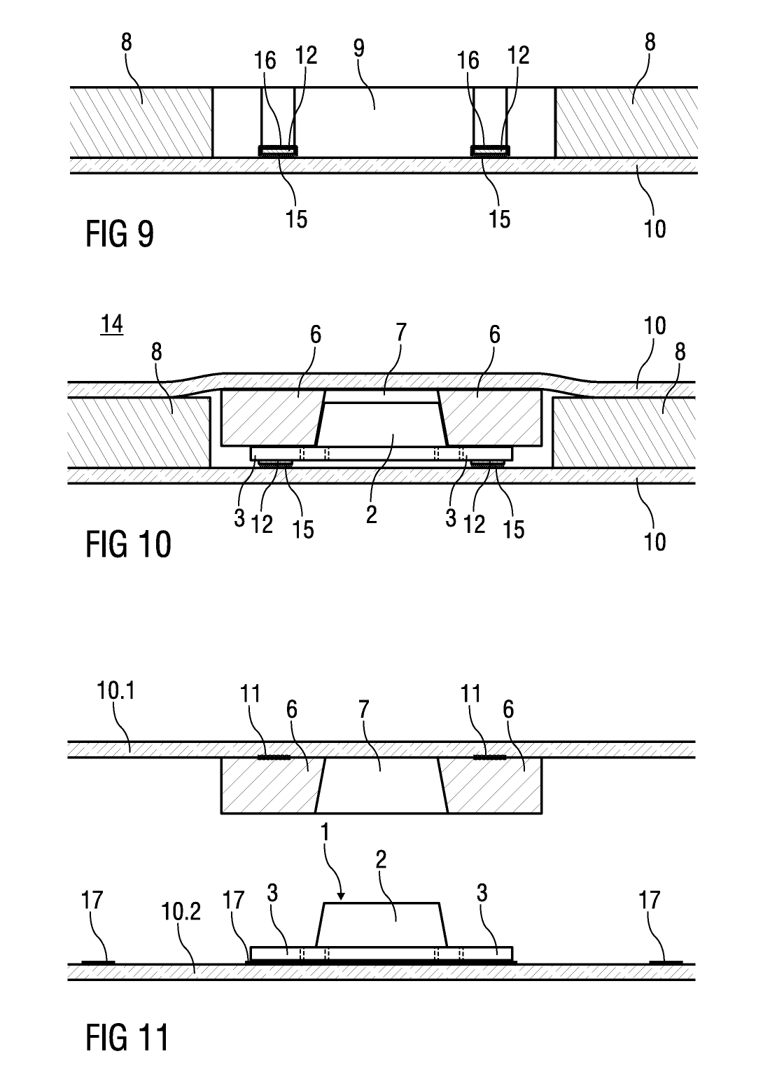

FIG. 9 shows the substrate layer and the cover layer according to FIG. 8, wherein contact points of the conductor strip are pressed onto the lower cover layer;

FIG. 10 shows the substrate layer and the cover layer according to FIG. 9 subsequent to the insertion of the preassembled molded part;

FIG. 11 shows a cover layer having the affixed molded part and an additional cover layer having the affixed chip module;

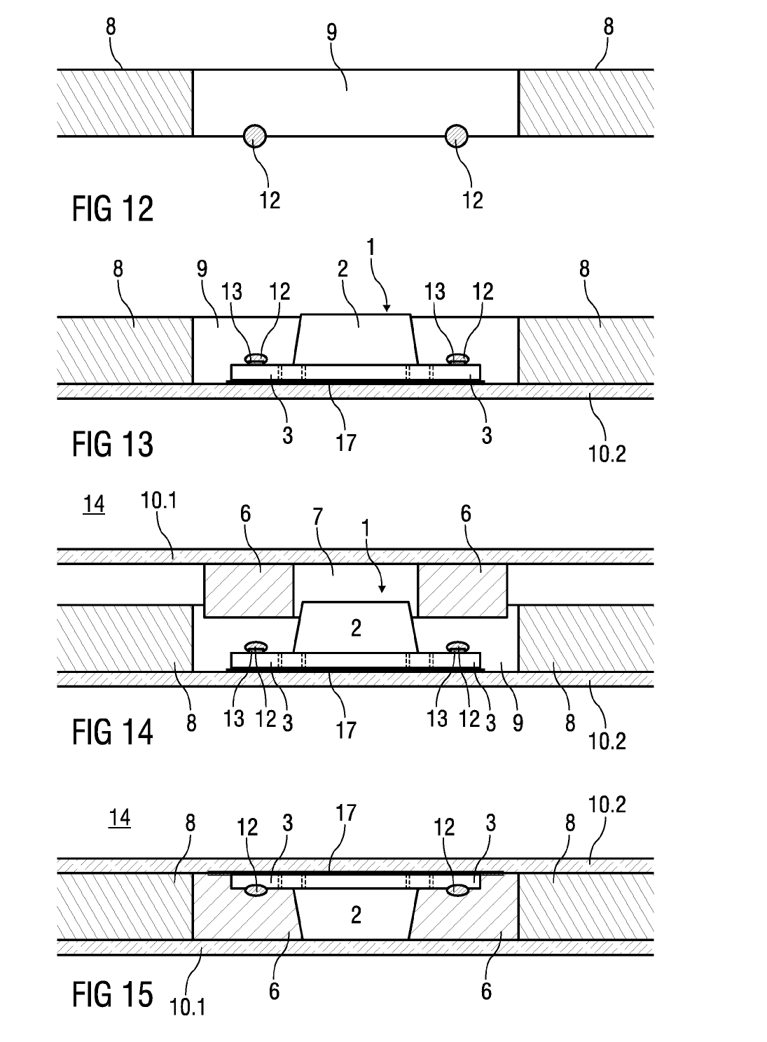

FIG. 12 shows a cross-sectional view of a section of the substrate layer;

FIG. 13 shows the cover layer being affixed to the substrate layer according to FIG. 12 and having the chip modules according to FIG. 11 affixed thereon;

FIG. 14 shows the substrate layer and the cover layer according to FIG. 13 during assembly with the cover layer and the molded parts affixed thereto according to FIG. 11, and

FIG. 15 shows a functional laminate resulting from the assembly according to FIG. 14.

Equivalent parts in all figures are furnished with the same reference numerals.

FIG. 1 shows a cross-sectional view of a chip module 1, comprising a module body 2 and two terminals 3 for contacting with an antenna coil (not shown). The module body comprises an integrated electronic circuit 4 (chip) which is internally contacted with the terminals 3 with the aid of contact wires 5.

The chip module 1 for instance can have the following dimensions:

length of terminals: 3: 2.5 mm;

thickness of terminals 3: 0.08 mm;

length of module body: 2: 5 mm;

thickness of module body 2: 0.22 mm;

width of module body 2 and terminals 3: 5 mm.

FIGS. 2 and 3 show cross-sectional views of molded parts 6 for receiving the chip module 1 according to FIG. 1 in a molded part aperture 7. The molded part 6 can be produced for instance by molding, punching or by means of a cutting process. By the same token, molded parts 6 can be produced by hot-stamping or embedding of the chip module 1. For instance, the molded part 6 has a length of 13 mm, a width of 8 mm and a thickness of 0.35mm. The thickness of the molded part 6 is slightly larger than the total thickness of the terminals 3 and the module body 2. The molded part 6 is inserted into an aperture in the substrate layer (see FIGS. 6 to 10, 12 to 15), the surface thereof in the top view being slightly larger than the surface of the molded part 6 in the top view. A thickness of the substrate layer is almost as large as the total thickness of the terminals 3 and the module body 2, i.e. an overall thickness of the chip module. The molded part 6 is formed of an embedding material which is sufficiently temperature-resistant at the laminating temperature (for instance up to 200° C.) for a lamination period. For instance, temperature-resistant, thermoplastic polyurethane is selected as the embedding material. The molded part 6 serves as buffer material and reduces mechanical stresses in the substrate layer and the cover layers by reducing peak stress. The soft, elastic and temperature-resistant embedding material of the molded part 6 in the aperture largely evenly distributes compressive stresses occurring as a result of shrinkage in the lamination process and prevents lateral stresses acting onto the terminals 3 of the chip module 1, which may otherwise push the chip module 1 out of the plane. The embedding material has a thermal expansion coefficient which is at least as large as a thermal expansion coefficient of the material, at least of the substrate layer and preferably also of a cover layer (see FIGS. 6 to 11, 13 to 15).

FIG. 4 shows a molded part 6 produced by a cutting process subsequent to pressing of the module body 2 into the molded part aperture 7. A surface of the molded part aperture 7 in the top view is smaller than a surface of the module body 2. For the purpose of pressing, the chip module 1 is heated (for instance to 150° C.) such that the module body 2 can be pressed with relatively low compressive forces into the molded part aperture 7 having the dimensions of 4.7 mm×4.7 mm according to the example and subsequently is fixedly connected to the molded part 6. FIG. 5 shows the molded part 6 according to FIG. 4 in the top view.

In FIG. 6 a cover layer 10 was disposed below a substrate layer 8 having an aperture 9 for receiving the molded part 6. For instance, the aperture 9 has a size of 14.5 mm×9.5 mm and hence is larger than the outer dimensions of the molded part 6. The thickness of the cover layer 8 for instance is 0.30 mm, the thickness of the cover layer 10 for instance is 0.03 mm. The cover layer 10 and the substrate layer 8 can be thermally affixed to each other. The substrate layer 8 and the cover layer 10 can be formed of polycarbonate. The molded part 6 being preassembled with the chip module 1 is placed in the aperture 9 and is thermally affixed to the cover layer 10 at the attachment points 11. A circuit pattern in the form of an antenna coil is subsequently produced on an upper surface of the substrate layer 8 by laying a conductor strip 12, wherein the crossing areas with the contact points of the conductor strip 12 are directly drawn over the molded part 6 having the inserted chip module 1, respectively the terminals 3 of the chip module 1. For instance, the conductor strip 12 has a width of 0.3 mm and a thickness of 0.03 mm. Preferably, the conductor strip 12 is formed of copper and is furnished with an insulation 15 of a core lacquer and a baked lacquer. Subsequent to the laying of the conductor strip 12, the contact points thereof at the welding spots 13 are contacted with the terminals 3 of the chip module 1 by means of a welding contact by pulsed thermo-compression.

FIG. 7 shows a cross-sectional view of a functional laminate 14 in the form of a prelaminate. In this context, an additional cover layer 10 is affixed on the arrangement shown in FIG. 6 on the other side of the substrate layer 8 and is thermally prelaminated. This is performed for instance at a temperature of 190° C. over a period of 30 minutes.

Subsequently, the functional laminate 14 is cooled by applying pressure. The chip module 1 in the plane of the substrate layer 8 is embedded into the molded part 6 of thermoplastic polyurethane. The molded part 6, which was initially thicker than the substrate layer 8, here is thermally leveled in the aperture 9 of the substrate layer 8, wherein the size of the aperture 9 is slightly reduced due to shrinkage and flow processes. The upper and lower surfaces of the chip module 1 are not encased at all or are only slightly encased by the embedding material.

FIG. 8 shows the substrate layer 8 having the cover layer 10 affixed thereunder subsequent to the laying of the conductor strip 12 on the upper surface of the substrate layer 8 across the aperture 9. A chip module 1 at this point of time is not yet inserted into the aperture 9. In another step, the crossing areas of the conductor strip 12 are pressed onto the lower cover layer 10 using a preferably cold plunger of approximately the size of the molded part 6, as is shown in FIG. 9. Alternatively, the pressing-down of the crossing areas of the conductor strip 12 can be performed before the cover layer is affixed thereunder. By the same token, instead of the conductor strip 12 having a rectangular cross-section, a conductor wire 12 having a round cross-section can be used which is leveled to a conductor strip 12 upon pressing-down against an anvil in the area of the aperture 9, before the cover layer 10 is affixed thereunder. Subsequently, the insulation of the contact point between the conductor strip 12 and the terminal 3 is stripped using a CO₂ laser, and a solder paste 16 having a melting point below the temperature used for the prelamination is applied onto the conductor strip sections from which the insulation has been stripped. For instance, no-clean solder paste having a melting point below the prelamination temperature (example: tin-bismuth alloy having a melting point of 139° C.) can be used. Subsequently, the chip module 1 is inserted. The contacting is then performed during prelamination.

The described solder contacting can be used both for the conductor strip contact points pressed into the aperture 9 and the embodiments illustrated in FIGS. 6 and 7 and the further embodiments. For instance, the conductor wire 12 is guided across the aperture 9 and is leveled, the upper cover layer 10 is affixed thereon, the insulation of the contact points is stripped across the aperture 9, and the contacts points are coated with solder paste 16. Analogously, conductor strip 12 can be used instead of conductor wire 12, wherein the leveling of the conductor wire 12 can be omitted.

FIG. 10 shows the state subsequent to the insertion of the preassembled molded part 6 having the terminals 3 of the chip module 1 pointing downwardly into the aperture 9 and subsequent to the application of the upper cover layer 10. Following the subsequent prelamination, the same state as that shown in FIG. 7 is caused in the cross-section by the functional laminate 14. However, the circuit pattern formed by the conductor strips 12 is disposed on the side of the substrate layer 8 which points away from the terminals 3. Subsequently, further assembly processes can be performed on an assembly machine from the side of the functional laminate 14 where the circuit pattern is laid with the conductor wire 12 or conductor strips 12.

FIGS. 11 to 15 show another embodiment of a functional laminate 14 in the form of a prelaminate. Prelaminates are frequently produced in larger printed panels. Printed panels are thereby referred as a type of a sheet, on which frequently up to 64 prelaminates are disposed as a unit in gaps and rows. For reasons of production, clearances (webs) are usually provided between the surfaces of the prelaminates. In FIGS. 11 to 15 only a part of a printed panel is illustrated. The assembly of the prelaminate is distributed on both the cover layers 10 and the substrate layer 8.

Molded parts 6 are thermally affixed onto the cover layer 10.1 shown in FIG. 11 corresponding to the geometry of the printed panel. In the illustrated example, the molded part apertures 7 have a surface of 5.5 mm×5.5 mm. The molded part 6 has a thickness of 0.4 mm. Adhesive surfaces 17 of the dimensions of 13 mm×8 mm are printed on the cover film 10.2, onto which the chip modules 1 having the terminals 3 are placed. For instance adhesive from the company Kissel & Wolf, type 1500/2 with a thickness of 15 μm can be applied.

FIG. 12 shows a cross-sectional view of a section of the substrate layer 8, wherein the circuit pattern is produced by the laying of lacquer-insulated conductor wire 12 (core lacquer and baked lacquer) with a diameter of 112 μm.

In FIG. 13, the substrate layer 8 and the cover layer 10.2 having the affixed chip modules 1 are affixed to each other such that the terminals 3 press the contact points of the conductor wire 12 crossing the aperture 9 into the interior of the aperture 9. The contacting of the contact points of the conductor wire 12 with the terminals 3 is performed from the open side of the aperture 9 with the aid of pulsed thermo-compression. In this process, the cross-section of the conductor wire 12 is slightly deformed. It is also possible to use conductor strip 12 instead of conductor wire 12.

In FIG. 14, the cover layer 10.1 having the affixed molded parts 6 is laid and affixed on the upper surface of the substrate layer 8 such that the module bodies 2 protrude into the molded part apertures 7. Subsequently, prelamination is performed such that the state shown in FIG. 15 is realized.

Alternatively, it is possible to affix the molded parts 6 to the cover layer 10, 10.1, 10.2 with the aid of an adhesive.

The indicated sizes and dimensions are exemplary values and can be selected so as to differ from those indicated in all embodiments. Provision can be made for a functional component of a different type instead of the chip module 1, for instance a non-encapsulated (“naked”) chip.

The conductor strip or the conductor wire 12 guided across the aperture 9 is basically affixed to the substrate layer 8 on both sides of the aperture 9.

### LIST OF REFERENCE NUMERALS

1 Chip module, functional component

2 Module body

3 3 Terminal

4 Integrated electronic circuit

5 Contact wire

6 Molded part

7 Molded part aperture

8 Substrate layer

9 Aperture

10, 10.1, 10.2 Cover layer

11 Attachment point

12 Conductor strip, conductor wire

13 Welding spot

14 Functional laminate

15 Insulation

16 Solder paste

17 Adhesive surface

1. A method for producing a functional laminate, wherein the method comprises the following steps:
providing at least one thermoplastic film as a substrate layer;
producing at least one aperture in the substrate layer;
inserting at least one functional component into the aperture, said functional component being surrounded by a soft, elastic and temperature-resistant embedding material at least in the substrate layer, said embedding material having a thermal expansion coefficient and a shrinkage value which are each at least as large as a thermal expansion coefficient and a shrinkage value of the thermoplastic film; and
laminating the substrate layer with at least one additional film as the cover layer by applying pressure and supplying heat.

2. A method for producing a functional laminate, wherein the method comprises the following steps:
providing at least one thermoplastic film as a substrate layer;
producing at least one aperture in the substrate layer;
inserting at least one functional component in the form of one of a chip and a chip module, said one of a chip and a chip module having at least two terminals into the aperture;
laminating the substrate layer with at least one additional film as the cover layer by applying pressure and supplying heat;
laying a conductor material in or on the substrate layer to form a circuit pattern; and
contacting the-contact points of the conductor material forming the circuit pattern with the terminals, wherein crossing areas of the conductor material forming the circuit pattern, which comprise the contact points, are guided across the aperture on a laying side prior to assembly of the functional component and are bent into the aperture using at least one of a plunger and the functional component.

3. The method according to claim 2, in which a soft, elastic and temperature-resistant embedding material is disposed such that the functional component is surrounded by the embedding material at least in the substrate layer, said embedding material having a thermal expansion coefficient which is at least as large as a thermal expansion coefficient of the substrate layer, wherein the embedding material and the substrate layer exhibit a similar or the same shrinkage behavior when heated.

4. The method according to claim 1, in which the embedding material is formed as a molded part having a molded part aperture, wherein the functional component is at least partially inserted into the molded part aperture, wherein the molded part is inserted into the aperture of the substrate layer prior to or after insertion of the functional component.

5. The method according to claim 4, in which a surface of the molded part having the inserted functional component in a top view is smaller than a surface of the aperture, wherein a thickness of the molded part is larger than or equal to a thickness of the substrate layer.

6. The method according to claim 4, in which the functional component is one of pressed and molded into the molded part.

7. The method according to claim 4, in which the contact points of the conductor material forming the circuit pattern, are conductively contacted with the terminals prior to or after assembly of the functional component having the molded part.

8. The method according to claim 4, in which the molded part is produced using a method selected from a group consisting of casting, hot-stamping or a cutting, and embedding of the functional component.

9. The method according to claim 4, in which the molded part aperture is smaller than a part of the functional component inserted therein, wherein the part of the functional component is pressed into the molded part aperture.

10. The method according to claim 9, in which the molded part having the functional component is inserted into the aperture and is affixed to the cover layer.

11. The method according to claim 2, in which the crossing areas of the conductor material forming the circuit pattern are guided across the aperture on a laying side and are bent through the aperture to a side of the substrate layer opposite to the laying side, and the one of the chip module and the chip is subsequently inserted into the aperture with the terminals thereof pointing ahead.

12. The method according to claim 2, in which the contact points pressed against an anvil and are leveled.

13. The method according to claim 4, in which the functional laminate includes at least two cover layers and the molded part is affixed to one of the cover layers, wherein the functional component is affixed to another one of the cover layers, wherein the circuit pattern on the substrate layer is laid with crossing areas of the conductor material forming the circuit pattern being guided across the aperture, wherein the substrate layer and the cover layer are affixed to the functional component such that the terminals of the functional component bend the crossing areas of the conductor material forming the circuit pattern into the aperture, such that the contact points lie below the terminals, whereupon the contacting is performed, wherein the cover layer having the molded part is affixed to the substrate layer and is subsequently laminated.

14. A functional laminate, comprising:
at least one thermoplastic film as the substrate layer;
at least one aperture in the substrate layer;
at least one functional component disposed in the aperture;
at least one additional film as a cover layer laminated to the substrate layer; and a soft, elastic and temperature-resistant embedding material surrounding the functional component least almost exclusively in the substrate layer, said embedding material having a thermal expansion coefficient and a shrinkage value which are each at least as large as a thermal expansion coefficient and a shrinkage value of the substrate layer.

15. The functional laminate according to claim 14, produced by means of a method according to claim 1.

16. The method according to claim 1, in which the embedding material is formed as a molded part having a molded part aperture, wherein the functional component is at least partially inserted into the molded part aperture, wherein the molded part is inserted into the aperture of the substrate layer prior to or after insertion of the functional component.
